(19) United States
(12) Patent Application Publication
(10) Pub. No.: US 2013/0314660 A1
(43) Pub. Date: Nov. 28, 2013

(54) LENS AND FRAME ASSEMBLY FOR GLASSES

(71) Applicant: HIGH RAINBOW ENT, CO., LTD, Tainan City (TW)

(72) Inventor: WEI-SHENG CHEN, Tainan City (TW)

(73) Assignee: HIGH RAINBOW ENT, CO., LTD, TAINAN CITY (TW)

(21) Appl. No.: 13/842,014

(22) Filed: Mar. 15, 2013

(30) Foreign Application Priority Data
May 24, 2012 (TW) 101118491

(51) Int. Cl. G02C 1/00

(52) U.S. Cl. CPC G02C 1/10
USPC 351/86; 351/140

(57) ABSTRACT

A lens and frame assembly for glasses includes a lens having at least a latch and a frame having at least an inserting hole. After the lens is inserted into an embedding slot of the frame, the latch of the lens is inserted into the inserting hole of the frame to reinforce fastening the lens on the frame. When the glasses is twisted or impacted, the lens does not easily come off.

### CROSS-REFERENCE TO RELATED APPLICATION

This application claims priority from Taiwan Patent Application No. 101118491, filed on May 24, 2012, in Taiwan Intellectual Property Office, the contents of which are hereby incorporated by reference in their entirety

### BACKGROUND OF THE INVENTION

1. Field of the Invention

The present invention relates to a lens and frame assembly for glasses, and more particularly to a lens having a latch, wherein the lens is mounted on the frame by inserting the latch into an inserting hole of the frame so as to enhance the connection between the lens and the frame.

2. Description of the Related Art

Manners of fastening lenses with a frame in the market currently have the following ways. For example, the lenses can be connected to the frame through embedding slots in a full-frame type glasses. Alternatively, one end of nosepieces and foot stands of a half-frame glasses, which are in contact with the lenses, are respectively disposed with coupling members for fastening the lenses. However, the foregoing connection ways are unable to take serious impact or twisting at certain degrees. When the lenses receive heavy impact or the frame is imposed with certain twisting, the lenses usually fall to cause unnecessary damage and danger. Therefore, a mechanism capable of enhancing and fastening the lenses in the frame is required, and much shape change must be avoided to reduce affecting the appearance of the glasses.

### SUMMARY OF THE INVENTION

Therefore, upon the foregoing problems of prior art, it is an objective of the present invention to provide a lens and frame assembly for glasses so as to provide a more stable assembly structure for lens and the frame.

To achieve the foregoing objective, a lens and frame assembly for glasses comprises at least a lens having an edge from which a latch is outwardly extended; and a frame comprising an upper frame body and a lower frame body, which are jointly provided with at least an opening for placing the lens.

The frame has an embedding slot located in the upper frame body and the lower frame body and adjacent to the opening such that the lens is embedded into the frame through the embedding slot, wherein the frame further has at least an inserting hole in the embedding slot at a location and with a size corresponding to that of the latch for fastening the lens on the frame by inserting the latch into the frame through the inserting hole, wherein a quantity of the inserting hole located at the upper frame body and the lower frame body is at least one, namely, one or more than one.

The lens and frame assembly for glasses of the present invention further comprises a filler located at one end of the inserting hole, wherein a surface of the filler is leveled to a surface of the frame. The filler may be integrally formed with the upper frame body or the lower frame body.

Preferred, the upper frame body and the lower frame body are integrally flamed.

The upper frame body can be detachably connected to the lower frame body, and the upper frame body and the lower frame body further comprise a coupling member. The coupling member locks two side edges of the upper frame body and two side edges of the lower frame body or locks a central portion of the upper frame body and a central portion of the lower frame body.

The two side edges of the upper frame body are detachably connected to the two side edges of the lower frame body. The upper frame body and the lower frame body further comprise a coupling member. The coupling member locks the two side edges of the upper frame body and the two side edges of the lower frame body.

The glasses can be a full-frame type glasses.

The lens and frame assembly for glasses has one or more advantages as the following:

1. The lens of the glasses can be fastened on the frame of the glasses in an enhanced manner by inserting the latches of the lens into the inserting holes of the frame.

2. The glasses can be a full-frame type glasses to enhance the structural strength of the present invention.

3. The lens and frame assembly for glasses of the present invention can enhance the fastening strength between the lens and the frame to co-exit the beauty and rigidity.

### BRIEF DESCRIPTION OF THE DRAWINGS

The detailed structure, operating principle and effects of the present invention will now be described in more details hereinafter with reference to the accompanying drawings that show various embodiments of the present invention as follows.

FIG. 1 is an exploded view showing a lens and frame assembly for glasses according to a first embodiment of the present invention;

FIG. 2 is an exploded view showing a lens and frame assembly for glasses according to a second embodiment of the present invention;

FIG. 3 is an exploded view showing a lens and frame assembly for glasses according to a third embodiment of the present invention;

FIG. 4 is an exploded view showing a lens and frame assembly for glasses according to a fourth embodiment of the present invention;

FIG. 5 is an exploded view showing a lens and frame assembly for glasses according to a fifth embodiment of the present invention;

FIG. 6 is a cross-sectional view showing a lens and frame assembly for glasses according to a fifth embodiment of the present invention.

### DETAILED DESCRIPTION OF THE PREFERRED EMBODIMENTS

The technical content of the present invention will become apparent by the detailed description of the following embodiments and the illustration of related drawings as follows.

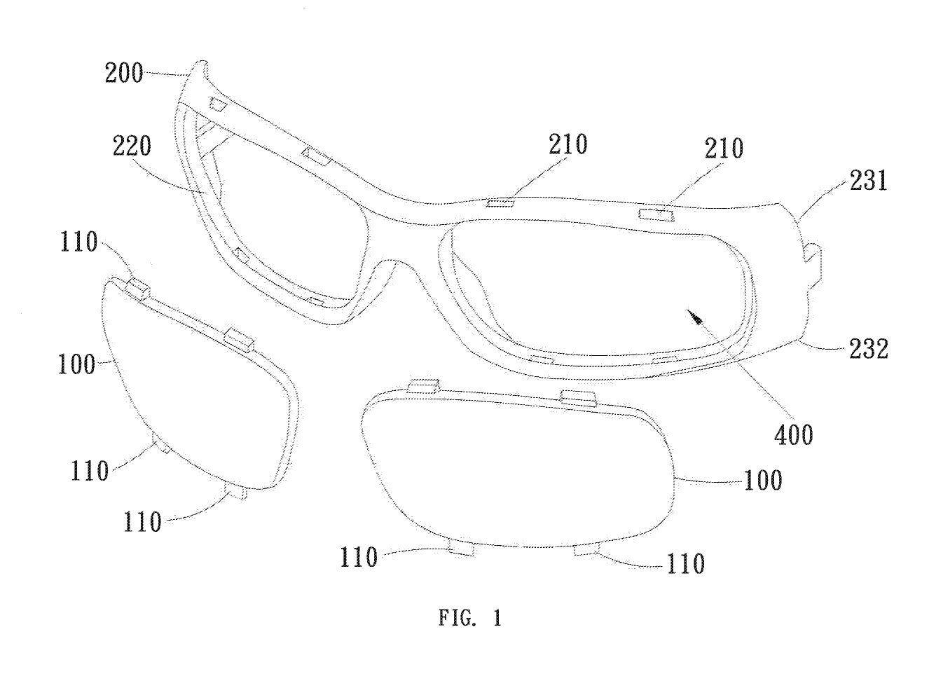

With reference to FIG. 1, an exploded view showing a lens and frame assembly for glasses according to a first embodiment of the present invention is depicted. In the figure, the lens and frame assembly for glasses comprises: at least a lens 100, wherein the lens 100 has at least a latch 110; a frame 200 having an upper frame body 231 and a lower frame body 232, wherein the upper frame body 231 and the lower frame body 232 are jointly provided with at least an opening 400 for mounting therein the lens 100, and an embedding slot 220 is formed at the upper frame body 231 and the lower frame body 232 and adjacent to the opening 400. The frame 200 further has at least an inserting hole 210 located in the embedding slot 220, wherein the latch 110 is outwardly extended from an edge of the lens 100. For example, the latch 110 can be outwardly extended in parallel with the surface of the lens 100 or outwardly extended at an angle from the edge of the lend 100. The foregoing angle can be adjusted in accordance with a connection angel between the upper frame body 231 and the lower frame body 232 and the lens 100. The inserting hole 210 is designed to longitudinally pass through the frame 200, and the location of the inserting hole 210 and the size of the opening hole of the inserting hole 210 are designed to correspond to that of the latch 110 so that the latch 110 can be correspondingly inserted into the inserting hole 210.

As shown in FIG. 1, the upper frame body 231 and the lower frame body 232 according to the first embodiment of the present invention are integrally formed. The upper frame body 231 and the lower frame body 232 are provided with two openings 400 for mounting therein two lenses 100 so as to form a full-frame type assembly. The lens 100 has four latches 110 on the top and bottom edges thereof. The frame 200 also has four correspondingly arranged inserting holes 210 on the top and bottom edges thereof, wherein these four inserting holes 210 are designed to longitudinally pass through the frame 200. For the purpose of fastening the lenses 100 onto the frame 200, the latches 110 of the lenses 100 are inserted into the inserting holes 210 of the frame 200, and then the edges of the lenses 100 are lodged into the embedding slot 220 of the frame 200 to fasten the lenses 100 on the frame 200 such that the assembly of the first embodiment of the present invention is completed. By comparing with the conventional glasses that have no latches and inserting holes, the lenses 100 and the frame 200 according to the first embodiment of the present invention can provide higher fastening strength. The inserting hole 210 has a first inserting opening 211 on one side of the frame 200 on which the embedding slot 220 is formed, and the inserting hole 210 also has a second inserting opening 212 on the other side of the frame 200. In addition, a filler is optionally inserted into the second inserting opening 212 of the insetting hole 210, wherein the filler has a surface leveled with the surface of the frame 200 to smoothen the surface of the frame 200.

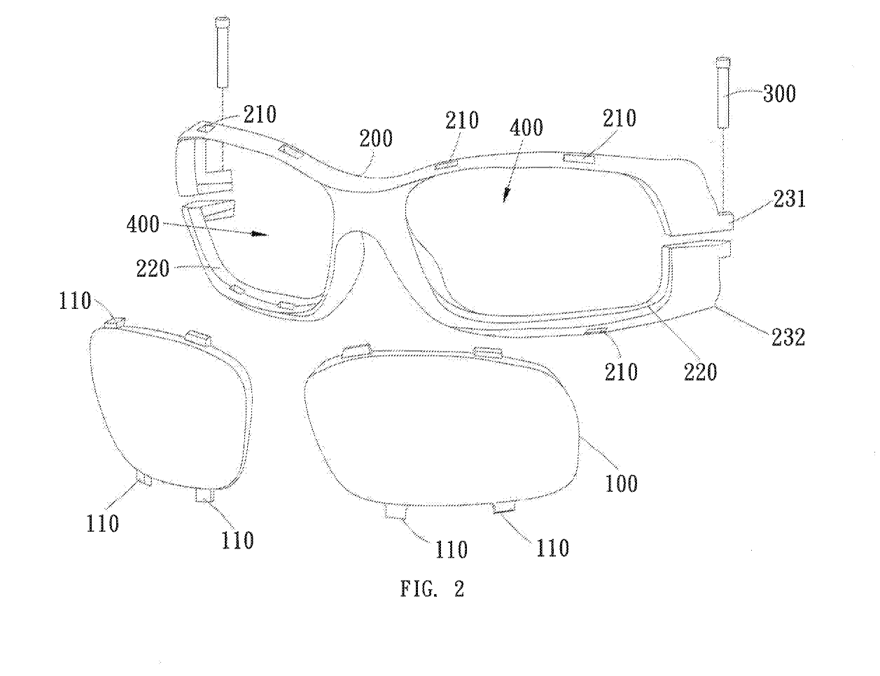

With reference to FIG. 2, an exploded view showing a lens and frame assembly for glasses according to a second embodiment of the present invention is depicted. In the figure, the upper frame body 231 and the lower frame body 232 according to the second embodiment of the present invention are further provided with two openings 400 for mounting two lenses 100. Two side edges of the upper frame body 231 can be detachably connected with two side edges of the lower frame body 232 by using at least a coupling member 300 respectively. The coupling member 300 can, for example, be a screw. The coupling members 300 can fasten the two side edges of the upper frame body 231 and the two side edges of the lower frame body 232 through screw locking or latch locking to form a full-frame type frame 200. Each of the lenses 100 has four latches 110 on the top and bottom edges thereof. The frame 200 also has four correspondingly inserting holes 210 on the top and bottom edges thereof. These four inserting holes 210 are designed to longitudinally pass through the frame 200. For the purpose of fastening the lenses 100 onto the frame 200, the lenses 100 are placed into the embedding slots 220 of the frame 200, and the latches 110 of the lenses 100 are inserted into the inserting holes 210. Thereafter, the coupling members 300 are utilized to lock two side edges of the upper frame body 231 and two side edges of the lower frame body 232 so as to obtain the second embodiment of the present invention. Alternatively, the two side edges of the upper frame body 231 and the two side edges of the lower frame body 232 may respectively have at least a coupling member, and the coupling member at the two side edges of the upper frame body 231 and the coupling member at the two side edges of the lower frame body 232 are locked and connected to each other. When the second embodiment of the present invention is seriously impacted or twisted at certain degrees, the lenses 100 can be retained and fastened on the frame 200 through the latches 110 and the inserting holes 210. Besides, the inserting hole 210 further has a first inserting opening 211 on one side of the frame 200 on which the embedding slot 220 is formed, and the inserting hole 210 also has a second inserting opening 212 on the other side of the frame 200. Optionally, a filler is inserted into the second inserting opening 212 of the inserting hole 210, Wherein the filler has a surface leveled with the surface of the frame 200 to smoothen the surface of the frame 200.

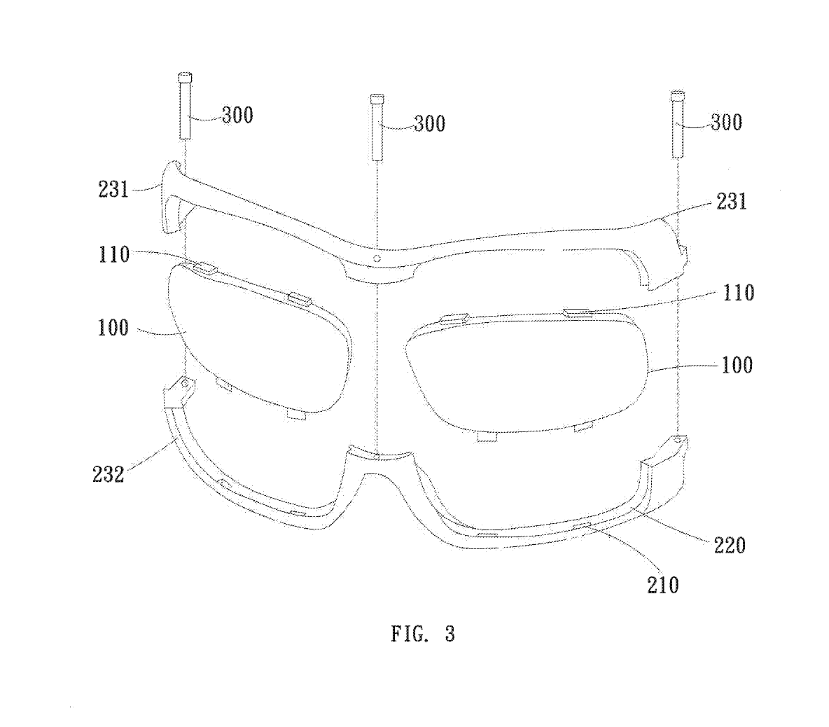

With reference to FIG. 3, an exploded view showing a lens and frame assembly for glasses according to a third embodiment of the present invention is depicted. In the figure, upper frame body 231 and the lower frame body 232 of the third embodiment are separated from each other, wherein the upper frame body 231 is detachably connected to the lower frame body 232 so as to provide two openings 400 for placing the two lenses 100. The two side edges of the upper frame body 231 and the two side edges of the lower frame body 232 respectively can be detachably connected with each other by using at least a coupling member 300. Besides, a central portion of the upper frame body 231, and a central portion of the lower frame body 232 may also detachably connected with each other by using a coupling member 300. Each of the coupling members 300 can, for example, be a screw. The coupling members 300 can fasten the two side edges of the upper frame body 231 and the two side edges of the lower frame body 232 and/or a central portion of the upper frame body 231 and a central portion of the lower frame body 232 by means of screw locking or latch locking, thereby forming a full-frame type frame 200. Each of the lenses 100 totally has four latches 110 on the top and bottom edges thereof. The frame 200 also has four correspondingly arranged inserting holes 210 on the top and bottom edges thereof. However, it should be noted that the four inserting holes 210 do not pass through the frame 200. Namely, in this embodiment, the filler is integrally formed with the upper frame body 231 or the lower frame body 232. For the purpose of fastening the lenses 100 onto the frame 200, the lenses 100 are placed in the embedding slot 220 of the frame 200, and the latches 110 of the lenses 100 are inserted into the inserting holes 210. Thereafter, the two side edges of the upper frame body 231 and the two side edges of the lower frame body 232 are locked and connected to each other by the coupling members 300. In addition, the central portion of the upper frame body 231 and the central portion of the lower frame body 232 may also be locked and connected to each other by the coupling member 300 so as to complete the third embodiment of the present invention. According to the third embodiment of the present invention, multiple locking and combination ways of the latches 110 and the inserting holes 210 are provided.

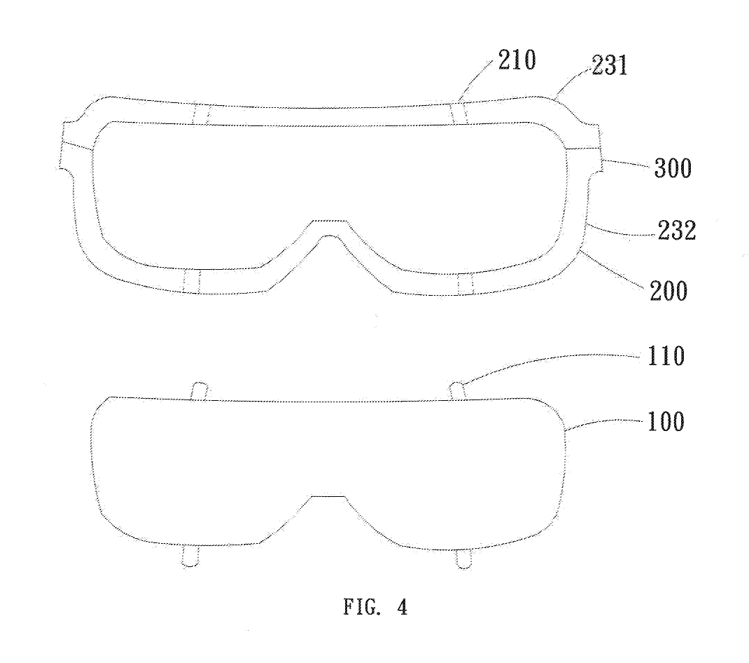

With reference to FIG. 4, an exploded view showing a lens and frame assembly for glasses according to a fourth embodiment of the present invention is depicted. In the figure, the upper frame body 231 and the lower frame body 232 according to the fourth embodiment of the present invention are fowled with one opening 400 for placing one lens 100. The two side edges of the upper frame body 231 can be detachably connected to the two side edges of the lower frame body 232. The two side edges of the upper frame body 231 and the two side edges of the lower frame body 232 are respectively connected by using a coupling member 300. Only one piece of lens 100 is provided in the fourth embodiment. The lens 100 totally has four latches 110, and the frame 200 also has four correspondingly arranged inserting holes 210. For the purpose of fastening the lens 100 onto the frame 200, the lens 100 is placed in. the embedding slot 220 of the frame 200, and the latches 110 of the lens 100 are inserted into the inserting holes 210 respectively. Thereafter, the coupling members 300 are utilized to lock and connect the two side edges of the upper frame body 231 with the two side edges of the lower frame body 232 so as to complete the four embodiment of the present invention. The lens 100 of the present invention can be different kinds of lens such as one or plural pieces.

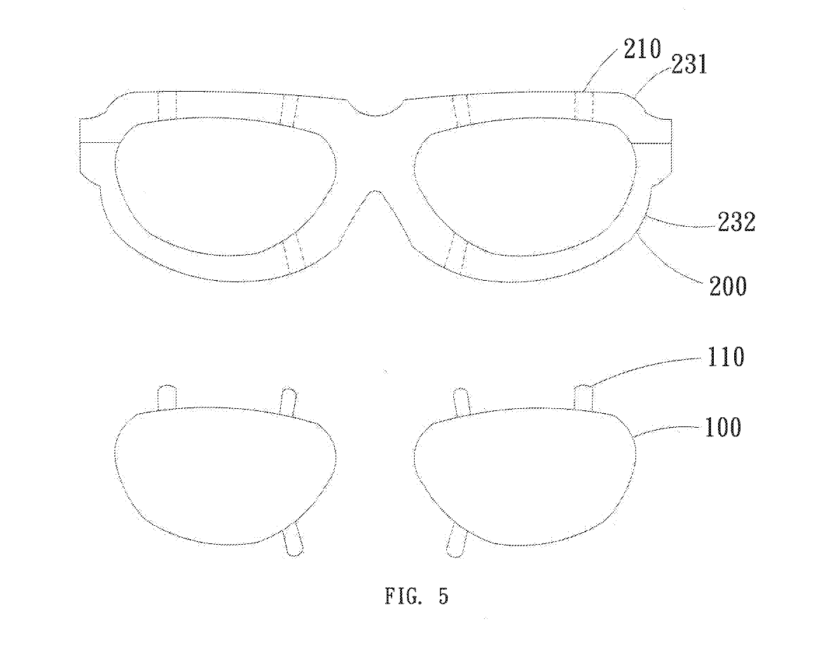

With reference to FIG. 5, an exploded view showing a lens and frame assembly for glasses according to a fifth embodiment of the present invention is depicted. In the figure, the lens 100 has two latches 110 at an upper half portion while it has one latch 110 at a lower half portion. The upper frame body 231 of the frame 200 has two inserting holes 210 corresponding to the latches 110 at an upper half portion while the lower frame body 232 has an inserting hole 210 corresponding to the latch 110 at a lower half portion. It should be noted that the upper frame body 231 or the lower frame body 232 of the present invention has one or more inserting holes 210. The lenses 100 also have one or more latches 110.

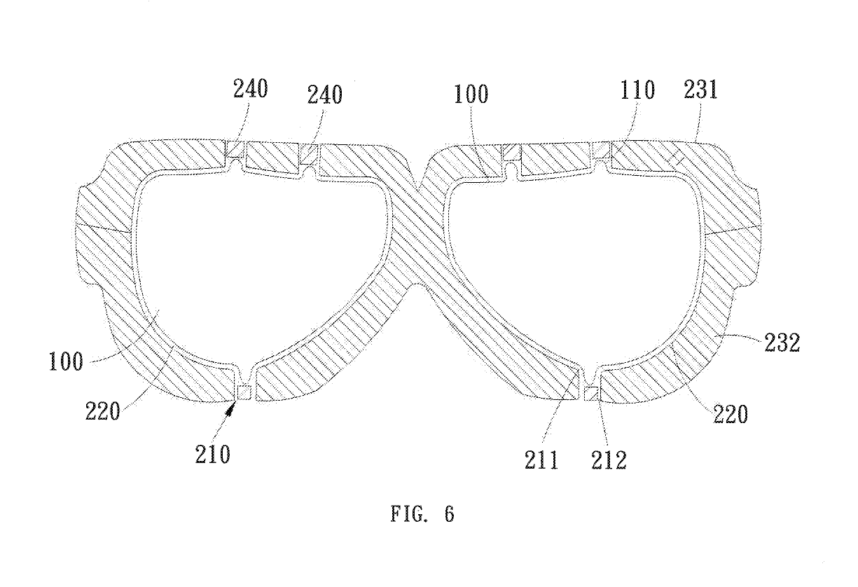

With reference to FIG. 6, a cross-sectional view showing a lens and frame assembly for glasses according to a fifth embodiment of the present invention is depicted. In the figure, the inserting holes 210 of the present invention are designed to longitudinally pass through the frame 200 from the embedding slot 220. The angle of the inserting hole 210 passing through the frame 200 is designed to correspond to the angle of the latch 110. The inserting hole 210 has a first inserting opening 211 on one side of the frame 200 on which the embedding slot 220 is formed, and the inserting hole 210 also has a second inserting opening 212 on the other side of the frame 200. A filler 240 is further inserted into the inserting hole 210. For example, the filler 240 can be detachably located at the second inserting opening 212 of the inserting hole 210, wherein the filler 240 has a surface leveled with the surface of the frame 200 to smoothen the surface of the frame 200.

While the means of specific embodiments in the present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A lens and frame assembly for glasses, comprising:
at least a lens having an edge from which a latch is outwardly extended; and
a frame having an upper frame body and a lower frame body, which are jointly provided with at least an opening for placing the lens, wherein the frame further has an embedding slot located in the upper frame body and the lower frame body and adjacent to the opening so as to embed the lens into the frame through the embedding slot, wherein the frame further has at least an inserting hole in the embedding slot at a location and with a size corresponding to that of the latch for fastening the lens on the frame by inserting the latch into the inserting hole of the frame.

2. The lens and frame assembly for glasses of claim I, wherein the inserting hole is designed to longitudinally pass through or not pass through the frame.

3. The lens and frame assembly for glasses of claim 2, further comprising a filler located at one end of the inserting hole, wherein a surface of the filler is leveled to a surface of the frame.

4. The lens and frame assembly for glasses of claim 1, wherein the upper frame body and the lower frame body are integrally formed.

5. The lens and frame assembly for glasses of claim 1, wherein the upper frame body is detachably connected to the lower frame body.

6. The lens and frame assembly for glasses of claim 5, further comprising a coupling member, wherein the coupling member locks two side edges of the upper frame body and two side edges of the lower frame body or locks a central portion of the upper frame body and a central portion of the lower frame body.

7. The lens and frame assembly for glasses of claim 1, wherein two side edges of the upper frame body are detachably connected to two side edges of the lower frame body.

8. The lens and frame assembly for glasses of claim 7, further comprising a coupling member, wherein the coupling member locks the two side edges of the upper frame body and the two side edges of the lower frame body.

9. The lens and frame assembly for glasses of claim 1, wherein a quantity of the inserting hole located at the upper frame body and the lower frame body is at least one.
